(19) United States
(12) Patent Application Publication
(10) Pub. No.: US 2011/0042936 A1
(43) Pub. Date: Feb. 24, 2011

(54) SWIVEL ASSEMBLIES FOR LOADING ARMS AND LOADING ARMS COMPRISING THE SAME

(75) Inventor: Bradley S. Andrews, Spring Valley, OH (US)

Correspondence Address: DINSMORE & SHOHL LLP, 1900 CHEMED CENTER, 255 EAST FIFTH STREET, CINCINNATI, OH, 45202, US

(73) Assignee: OPW ENGINEERED SYSTEMS, Lebanon, OH (US)

(21) Appl. No.: 12/845,004

(22) Filed: Jul. 28, 2010

Related U.S. Application Data
(60) Provisional application No. 61/235,715, filed on Aug. 21, 2009.

(51) Int. Cl. F16L 27/00; F16L 25/00; F16L 27/08

(52) U.S. Cl. 285/94; 285/272

(57) ABSTRACT

A swivel assembly includes a lower flange assembly having lower body portion, a first rim portion extending around the lower body portion, and a first fluid passageway. An upper flange assembly includes an upper body portion, a second rim portion extending around the upper body portion, and a second fluid passageway. A mating collar is positioned around the upper body portion and secured to the first rim portion such that the second rim portion is rotatably positioned between the mating collar and the first rim portion and the first fluid passageway is fluidly coupled to the second fluid passageway. Bearing elements are disposed between the first rim portion and the second rim portion and between the second rim portion and the mating collar such that the upper flange assembly and a combination of the lower flange assembly with the mating collar are rotatable with respect to each other.

### CROSS-REFERENCE TO RELATED APPLICATIONS

The present specification claims priority to U.S. Provisional Patent Application 61/235,715 filed Aug. 21, 2009 and entitled “Swivel Assemblies,” the entirety of which is herein incorporated by reference.

### TECHNICAL FIELD

The present specification generally relates to swivel assemblies and, more specifically, to swivel assemblies for use in conjunction with piping components.

### BACKGROUND

As background, the transfer of bulk products (such as liquids, gases or solids (e.g., grain, flour, sugar, etc.) to or from a transport vehicle often requires the use of a loading arm which may comprise a number of articulated joints. One end of the loading arm may have a coupler which allows the loading arm to mate to a corresponding adapter on the transport vehicle. In order to transfer the bulk product, the loading arm may be moved to a position which permits the coupler to be coupled to the adapter.

In order to facilitate movement and positioning of the loading arm, one or more swivel joints (or swivel assemblies) may be used, which permit the pivoting of one section of pipe relative to another section of pipe. The swivel assembly may also provide mechanical support for the loading arm and the bulk product contained therein. Because of its pivoting characteristic, the possibility exists for the bulk product to leak out of the swivel assembly and into the environment. Similarly, the possibility exists for an environmental contaminant to leak into the swivel assembly.

Because of the requirements for both mechanical support and sealing, many of the existing swivel assemblies have a relatively complex design and may be difficult and/or expensive to manufacture. Consequently, a need exists for alternative swivel assembly designs which provide mechanical support, seal against leaks, and are easy to manufacture and assemble.

### SUMMARY

According to one embodiment, a swivel assembly for a loading arm includes a lower flange assembly comprising a lower body portion and a first rim portion extending around the lower body portion. The lower body portion generally defines a first fluid passageway. An upper flange assembly includes an upper body portion and a second rim portion extending around the upper body portion. The upper body portion generally defines a second fluid passageway. A mating collar is positioned around the upper body portion of the upper flange assembly and secured to the first rim portion of the lower flange assembly such that the second rim portion of the upper flange assembly is rotatably positioned between the mating collar and the first rim portion of the lower flange assembly and the first fluid passageway is fluidly coupled to the second fluid passageway. A first plurality of bearing elements are disposed between the first rim portion of the lower flange assembly and the second rim portion of the upper flange assembly and a second plurality of bearing elements are disposed between the second rim portion and the mating collar such that the upper flange assembly and a combination of the lower flange assembly with the mating collar are rotatable with respect to each other.

In another embodiment, a swivel assembly for a loading arm includes a lower flange assembly comprising a lower body portion and a first rim portion extending around the lower body portion. The lower body portion generally defines a first fluid passageway. The first rim portion includes a lower flange mating surface having a first half of a lower bearing race formed therein. An upper flange assembly includes an upper body portion and a second rim portion extending around the upper body portion. The upper body portion generally defines a second fluid passageway. The second rim portion includes a first upper flange mating surface with a second half of a lower bearing race formed therein. The second rim portion also includes a second upper flange mating surface with a first half of an upper bearing race formed therein. The lower flange mating surface of the lower flange assembly is positioned opposite the first upper flange mating surface such that the first half of the lower bearing race and the second half of the lower bearing race are aligned and the first fluid passageway is fluidly coupled to the second fluid passageway. A mating collar is positioned around the upper body portion of the upper flange assembly and secured to the first rim portion of the lower flange assembly such that the second rim portion of the upper flange assembly is rotatably positioned between the mating collar and the first rim portion of the lower flange assembly. The mating collar includes a second half of the upper bearing race and the second half of the upper bearing race and the first half of the upper bearing race are aligned. A first plurality of bearing elements are disposed in the lower bearing race and a second plurality of bearing elements are disposed in the upper bearing race such that the upper flange assembly and a combination of the lower flange assembly and the mating collar are rotatable with respect to each other.

According to yet another embodiment, a loading arm includes a swivel assembly having a lower flange assembly comprising a lower body portion and a first rim portion extending around the lower body portion. The lower body portion generally defines a first fluid passageway. An upper flange assembly includes an upper body portion and a second rim portion extending around the upper body portion. The upper body portion generally defines a second fluid passageway. A mating collar is positioned around the upper body portion of the upper flange assembly and secured to the first rim portion of the lower flange assembly such that the second rim portion of the upper flange assembly is rotatably positioned between the mating collar and the first rim portion of the lower flange assembly and the first fluid passageway is fluidly coupled to the second fluid passageway. A first plurality of bearing elements are disposed between the first rim portion of the lower flange assembly and the second rim portion of the upper flange assembly and a second plurality of bearing elements disposed between the second rim portion and the mating collar such that the upper flange assembly and a combination of the lower flange assembly with the mating collar are rotatable with respect to each other. A coupler pipe segment is fluidly coupled to the first fluid passageway of the lower flange assembly of the first swivel assembly. An intermediate pipe segment is fluidly coupled to the second fluid passageway of the upper flange assembly such that the coupler pipe and the intermediate pipe are rotatable with respect to one another, wherein the first swivel assembly fluidly couples the coupler pipe to the intermediate pipe.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 depicts a swivel assembly according to one or more embodiments shown and described herein;

FIG. 2 depicts an exploded cross section of the swivel assembly of FIG. 1 according to one or more embodiments shown and described herein;

FIG. 3 depicts a cross section of a swivel assembly according to one or more embodiments shown and described herein;

FIG. 4 depicts a cross section of a swivel assembly according to one or more embodiments shown and described herein;

FIG. 5 depicts a cross section of a swivel assembly according to one or more embodiments shown and described herein; and

FIG. 6 depicts a loading arm with swivel assemblies according to one or more embodiments shown and described herein.

### DETAILED DESCRIPTION

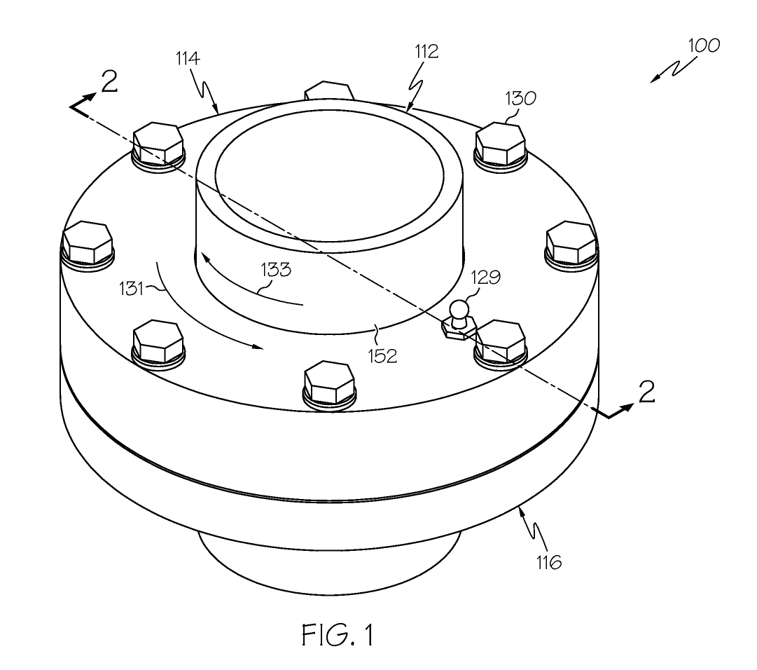

The embodiments described herein generally relate to swivel assemblies for piping components used in the transfer of bulk products and, more specifically, to swivel assemblies for use in loading arms. FIG. 1 generally depicts one embodiment of a swivel assembly for use in a loading arm. The swivel assembly generally comprises a lower flange assembly, an upper flange assembly and a mating collar. The mating collar and the lower flange assembly are coupled together such that a portion of the upper flange assembly is positioned between that lower flange assembly and the mating collar. The upper flange assembly and the combination of the lower flange assembly and the mating collar are rotatable with respect to one another. The swivel assemblies and loading arms incorporating the swivel assemblies will be described in more detail herein.

Referring now to FIG. 1, a perspective view of a swivel assembly 100 is schematically illustrated. The swivel assembly 100 generally comprises an upper flange assembly 112, a mating collar 114, and a lower flange assembly 116. The mating collar 114 is positioned around a body portion of the upper flange assembly 112 and secured to the lower flange assembly 116 such that the upper flange assembly and the combination of the lower flange assembly 116 and the mating collar 114 are free to rotate with respect to one another, as indicated by arrows 131, 133.

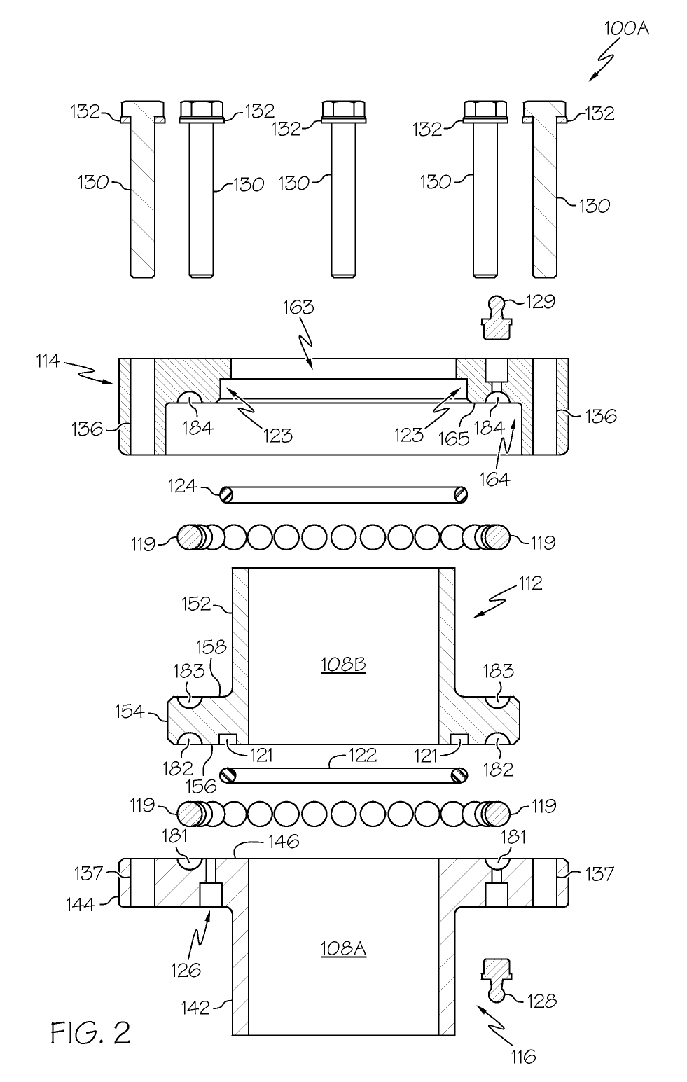

Referring now to FIG. 2, an exploded cross section of the swivel assembly of FIG. 1 is illustrated according to one embodiment described herein. The swivel assembly 100A generally comprises an upper flange assembly 112, a mating collar 114, and a lower flange assembly 116, as described above. The lower flange assembly 116 is formed from a metallic material, such as aluminum alloys, ferrous-based alloys, nickel-based alloys, nickel-copper-based alloys. Alternatively, lower flange assembly 116 may be made from polymeric materials, ceramics, and/or composites. The lower flange assembly 116 generally comprises a lower body portion 142 and a first rim portion 144. The lower body portion 142 is generally cylindrical and defines a first fluid passageway 108A which extends through the lower flange assembly 116. The first rim portion 144 is disc-shaped and extends around the lower body portion 142 at one end of the lower body portion 142. The first rim portion 144 is generally perpendicular to the lower body portion 142. The first rim portion 144 comprises a generally planar lower flange mating surface 146. A first half 181 of a lower bearing race is formed in the lower flange mating surface 146 and extends around the first fluid passageway 108A. The first rim portion 144 also comprises a plurality of threaded holes 137 formed around the perimeter of the first rim portion 144. In the embodiments shown herein, the lower body portion 142 is integrally formed with the first rim portion 144, such as when the lower flange assembly 116 is cast or machined as a single, integral piece. However, it should be understood that the lower flange assembly 116 may be formed by welding the first rim portion 144 to the lower body portion 142.

The upper flange assembly 112 is formed from a metallic material, such as aluminum alloys, ferrous-based alloys, nickel-based alloys, nickel-copper-based alloys. Alternatively, the upper flange assembly 112 may be made from polymeric materials, ceramics, and/or composites. The upper flange assembly generally comprises an upper body portion 152 and a second rim portion 154. The upper body portion 152 is generally cylindrical and defines a second fluid passageway 108B which extends through the upper flange assembly 112. The second rim portion 154 extends around the upper body portion 152 at one end of the upper body portion 152 and is generally perpendicular to the upper body portion 152. The second rim portion 154 comprises a generally planar first upper flange mating surface 156 and a generally planar second upper flange mating surface 158. The first upper flange mating surface 156 and the second upper flange mating surface 158 are substantially planar with one another. A second half 182 of a lower bearing race is formed in the first upper flange mating surface 156 and extends around the second fluid passageway 108B. A first half 183 of an upper bearing race is formed in the second upper flange mating surface 158 and extends around the upper body portion 152. In the embodiments shown herein, the upper body portion 152 is integrally formed with the second rim portion 154, such as when the upper flange assembly 112 is cast or machined as a single piece. However, it should be understood that the upper flange assembly 112 may be formed by welding the second rim portion 154 to the upper body portion 152.

In the embodiments described herein, the second rim portion 154 of the upper flange assembly 112 has an outer diameter which is less than the outer diameter of the first rim portion 144 of the lower flange assembly 116.

The second fluid passageway 108B of the upper flange assembly 112 and the first fluid passageway 108A of the lower flange assembly 116 are aligned with one another such that a continuous fluid passageway is formed through the swivel assembly 100. In one embodiment, a pipe or conduit (not shown) may be coupled to the upper body portion 152 of the upper flange assembly 112. Similarly, a pipe or conduit (not shown) may be mechanically coupled to the lower body portion 142 of the lower flange assembly 116. In one embodiment, the pipes or conduits may be attached to the upper body portion 152 and the lower body portion 142 by welding or a similar joining technique. In another embodiment, the upper flange assembly 112 and the lower flange assembly 116 may comprise a connection mechanism (not shown) to facilitate connecting the swivel assembly to the pipe. For example, the connection mechanism may comprise threads. In this embodiment, the swivel assembly 100A may be relatively compact and may offer more flexibility since many different types and lengths of pipes may be coupled to the swivel.

In the embodiments shown herein, the mating collar 114 is formed from a metallic material, such as aluminum alloys, ferrous-based alloys, nickel-based alloys, nickel-copper-based alloys. Alternatively, the mating collar may be made from polymeric materials, ceramics, and/or composites. The mating collar 114 is generally disc-shaped with a central opening 163 for receiving the upper body portion 152 of the upper flange assembly 112. The mating collar 114 is formed with a collar seat 164 for receiving the second rim portion 154 of the upper flange assembly 112. The collar seat 164 extends around the central opening 163 and comprises a generally planar collar mating surface 165, which is opposed to the second upper flange mating surface 158 when the swivel assembly 100A is assembled. The collar mating surface 165 is also formed with a second half 184 of the upper bearing race which, in conjunction with the first half 183 of the upper bearing race formed in the upper flange assembly 112, forms an upper bearing race. In the embodiments shown herein, the mating collar 114 also includes a plurality of through holes 136 situated around the perimeter of the mating collar 114. The through holes 136 correspond to the threaded holes 137 formed in the first rim portion of the lower flange assembly 116.

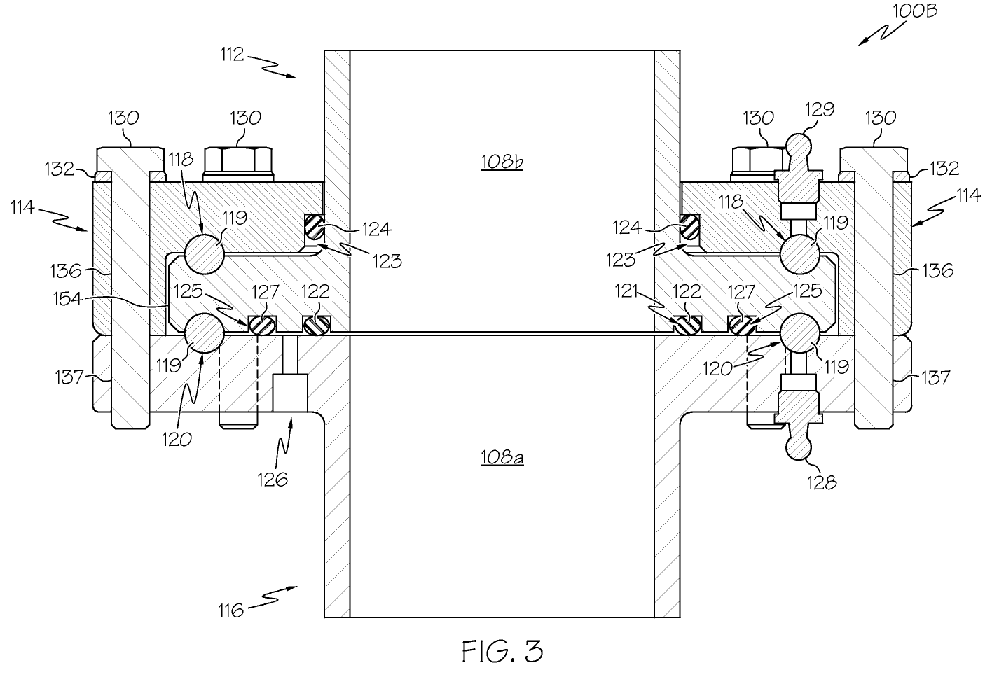

Still referring to FIG. 2, the mating collar 114 may be mechanically coupled to the lower flange assembly 116 with bolts 130 such that the upper flange assembly 112 is positioned between the mating collar 114 and the lower flange assembly 116. Specifically, the upper flange assembly 112 is positioned relative to the lower flange assembly 116 such that the first upper flange mating surface 156 is opposite and generally parallel to the lower flange mating surface 146 and the first half 181 of the lower bearing race is aligned with the second half 182 of the lower bearing race. In this orientation, the first fluid passageway 108A of the lower flange assembly 116 is aligned with and fluidly coupled to the second fluid passageway 108B of the upper flange assembly 112. The mating collar 114 is positioned on the upper flange assembly 112 such that the upper body portion 152 of the upper flange assembly 112 is received in the central opening 163 of the mating collar 114 and the second rim portion 154 of the upper flange assembly 112 is positioned in the collar seat 164. In this orientation, the second upper flange mating surface 158 is positioned opposite the collar mating surface 165 and the first half 183 of the upper bearing race is aligned with the second half 184 of the upper bearing race, such that, when the swivel assembly is assembled, the first half 183 of the upper bearing race and the second half 184 of the upper bearing race form an upper bearing race 118, as depicted in FIG. 3. Bolts 130 are positioned in the through holes 136 of the mating collar 114 and threaded into the threaded holes 137 formed in the lower flange assembly 116 thereby securing the mating collar 114 to the lower flange assembly 116. In one embodiment, lock washers 132 may be used in conjunction with the bolts.

In the embodiments of the swivel assemblies shown in FIGS. 2-5, the mating collar 114 and the lower flange assembly 116 are secured to each other with bolts 130, which pass through the through-holes 136 in the mating collar 114 and are threaded into the threaded holes 137 of the lower flange assembly 116. In an alternative embodiment (not shown), the mating collar 114 may be secured to the lower flange assembly 116 without the use of bolts. For example, the outer diameter of the lower flange assembly 116 may be reduced, and threads may be formed on the outer diameter of the first rim portion 144. The mating collar 114 may be formed to extend below the upper flange assembly 112 and may be threaded on the inner diameter such that the threads of the mating collar engage with the threads of the lower flange assembly 116. Thus, the mating collar 114 may be secured to the lower flange assembly 116 by threading the mating collar 114 onto the lower flange assembly 116 and tightening the mating collar to a suitable torque. A set screw or similar mechanism may be used to prevent loosening of the threaded flanges during normal operation.

As described above, the lower flange assembly 116 and the upper flange assembly 112 may define an annular lower bearing race in which a first plurality of bearing elements, such as ball bearings 119, are positioned. However, it should be understood that other types of bearing elements may be used. A first grease fitting 128 may be positioned in the first rim portion 144 and fluidly coupled to the lower bearing race. The grease fitting 128 permits lubrication to be periodically applied to the bearing elements in the lower bearing race.

An annular upper bearing race may be defined between the upper flange assembly 112 and the mating collar 114. Bearing elements, such as ball bearings 119, are disposed in the upper bearing race. A second grease fitting 129 is positioned in the mating collar 114 and fluidly coupled to the upper bearing race 118. The second grease fitting 129 permits lubrication to be periodically applied to the bearing elements in the upper bearing race.

The ball bearings 119 disposed in the upper bearing race and the lower bearing race permit the upper flange assembly 112 and the combination of the mating collar 114 and lower flange assembly 116 to rotate with respect to each other. The upper flange assembly 112, mating collar 114, and lower flange assembly 116 are designed so that the bearings are suitably loaded when the bolts 130 are fully tightened. Alternatively, the upper flange assembly 112, mating collar 114, and lower flange assembly 116 may be designed so that the bearings are suitably loaded when the bolts 130 are tightened to a specific torque. In this and other embodiments, lock washers 132 may be used to prevent the bolts 130 from loosening during normal operation.

In the embodiments of the swivel assembly described herein, an environmental seal 124 may be positioned between the upper body portion 152 of the upper flange assembly 112 and the mating collar 114. The environmental seal 124 prevents rain, dirt, and other environmental contaminants from entering the inner portions of the swivel assembly, including the upper bearing race 118, the lower bearing race 120 and the first and second fluid passageways 108A, 108B, thereby preventing fouling of the bearing elements and contamination of the fluid traveling in the first and second fluid passageways 108A, 108B. In one embodiment, a channel 123 of suitable size for receiving the environmental seal 124 is formed in the mating collar 114 and the environmental seal 124 is positioned in the channel 123. In an alternative embodiment (not shown), the channel for receiving the environmental seal 124 may be formed in the upper body portion 152 of the upper flange assembly 112. The environmental seal 124 may comprise an O-ring or a similar sealing ring. The environmental seal 124 may be constructed from rubber, nitrile, Teflon or another suitable seating material.

Still referring to FIG. 2, in the embodiments of the swivel assemblies described herein, the swivel assemblies further comprise at least one sealing element positioned between the first rim portion 144 of the lower flange assembly 116 and the second rim portion 154 of the upper flange assembly 112. For example, in the embodiment of the swivel assembly 100A depicted in FIG. 2, the sealing element is a fluid seal 122 positioned between the upper flange assembly 112 and the lower flange assembly 116 in order to keep fluid flowing through the first fluid passageway 108A and the second fluid passageway 108B contained within the swivel assembly 100A. In the embodiment of the swivel assembly 100A depicted in FIG. 2, the fluid seal 122 is disposed in an annular channel 121 formed in the first upper flange mating surface 156 of the second rim portion 154 of the upper flange assembly 112. However, it should be understood that the annular channel 121 may, in the alternative, be formed in the lower flange mating surface 146 of the lower flange assembly 116. The channel 121 is positioned radially outward from the first and second fluid passageways 108A, 108B and the fluid seal 122 is positioned within the channel 121. The fluid seal 122 may comprise an O-ring or a similar sealing ring formed from rubber, nitrile, Teflon or another suitable sealing material.

A leak detection port 126 is located in the lower flange assembly 112 radially outward from the sealing element (i.e., the fluid seal 122 in FIG. 2) such that the sealing element is positioned between the first and second fluid passageways 108A, 108B and the leak detection port 126. Any fluid which leaks past the fluid seal 122 exits the swivel assembly via the leak detection port 126. Thus, the leak detection port 126 provides a visual indication that fluid is leaking from the swivel assembly 100A. For example, a technician may periodically inspect the leak detection port 126 in order to determine whether any fluid is leaking from the swivel assembly 100A. Alternatively, a mechanical or electronic sensor may be installed in or near the leak detection port 126 so that the sensor is operable to detect any fluid leakage. The sensor may be electrically coupled to a monitoring system which may alert an operator of a leak.

As described herein, the mating collar 114 and the lower flange assembly 116 are coupled together. The bearing elements in the upper bearing race and lower bearing race facilitate rotating the upper flange assembly 112 and the combination of the mating collar 114 and lower flange assembly 116 with respect to one another. During this movement, the fluid seal 122 and environmental seal 124 conform to the shape of the mating surface with which each is in contact thereby maintaining the seal between the upper flange assembly 112 and the lower flange assembly 116 and between the mating collar 114 and the upper flange assembly. Furthermore, the bearing elements in the two races may transfer the torque of the loading arm (i.e., the torque due to the weight of the loading arm and/or the fluid contained therein) placed on the upper flange assembly 112 to the lower flange assembly 116 and vice versa. These bearing elements may operate such that, even in the presence of such forces, the upper flange assembly 112 and the combination of the mating collar 114 and the lower flange assembly 116 are free to rotate with respect to one another without binding.

The embodiment of the swivel assembly 100A shown in FIG. 2 may be assembled as follows. First, the bearing elements may be placed in the first half of the lower bearing race of the lower flange assembly 116, and the fluid seal 122 may be placed in the channel 121 of the upper flange assembly 112. Next, the upper flange assembly 112 may be assembled onto the lower flange assembly 116. The bearing elements may then be placed in the first half 183 of the upper bearing race 118 of the upper flange assembly 112, and the environmental seal 124 may be placed on the upper flange assembly 112. Finally, the mating collar 114 may be installed over the upper flange assembly 112, and the bolts 130 may be inserted through the lock washers 132 and mating collar 114 and threaded into the lower flange assembly 116. To complete the assembly, the bolts are tightened to a desired torque with a torque wrench or other suitable tool.

Referring now to FIGS. 3-5, alternative embodiments of swivel assemblies are schematically depicted. The swivel assemblies depicted in FIGS. 3-5 generally comprise a lower flange assembly 116, an upper flange assembly 112 and a mating collar 114, as described hereinabove with respect to FIG. 2. However, in the embodiments of the swivel assemblies depicted in FIGS. 3-5, the number, type and position of the sealing elements disposed between the upper flange assembly and the lower flange assembly vary. These embodiments will now be discussed in more detail below.

FIG. 3 depicts another embodiment of the swivel assembly 100B. In this embodiment, the swivel assembly 100B comprises a second fluid seal 127 in addition to the first fluid seal 122. The second fluid seal 127 is positioned between the upper flange assembly 112 and the lower flange assembly 116 and located radially outward from the first fluid seal 122. In the embodiment shown in FIG. 3, the second fluid seal 127 is positioned such that the leak detection port 126 is located between the first fluid seal 122 and the second fluid seal 127. Accordingly, it will be understood that the second fluid seal is operable to contain any fluid which exits the first and second fluid passageways 108A, 108B and bypasses the first fluid seal 122. In the embodiment of the swivel assembly 100B depicted in FIG. 3, the second fluid seal 127 is disposed in an annular channel 125 formed in the first upper flange mating surface 156 of the second rim portion 154 of the upper flange assembly 112. However, it should be understood that the annular channel 125 may, in the alternative, be formed in the lower flange mating surface 146 of the lower flange assembly 116. The channel 125 is positioned radially outward from the first and second fluid passageways 108A, 108B and the second fluid seal 127 is positioned within the channel 125. The second fluid seal 127 may comprise an O-ring or a similar sealing ring formed from rubber, nitrile, Teflon or another suitable sealing material.

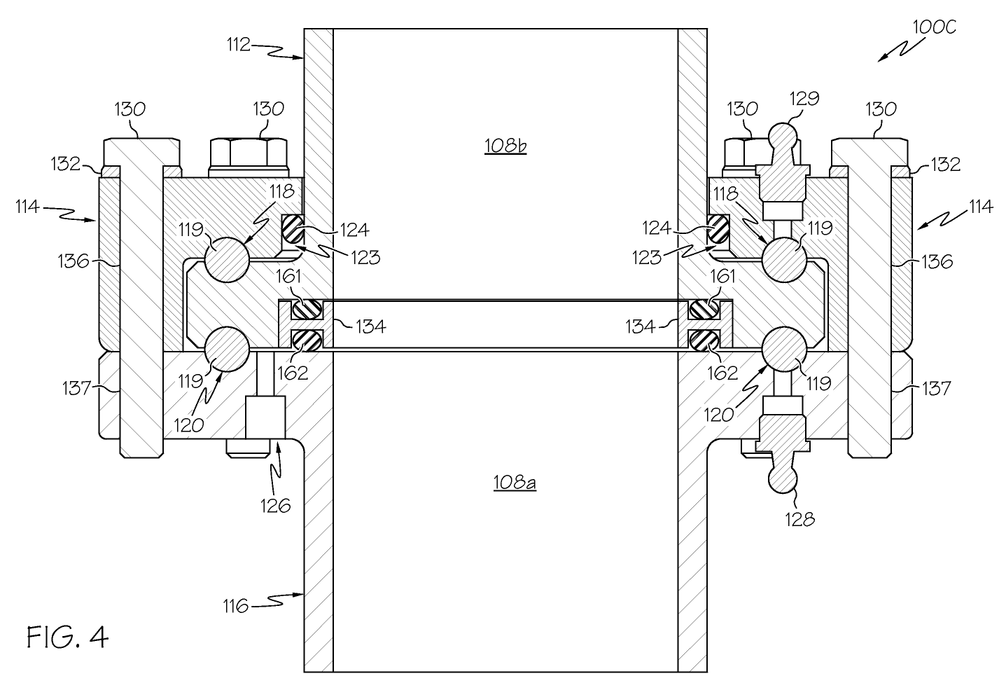

FIG. 4 depicts another embodiment of the swivel assembly 100C. In this embodiment, the sealing element comprises a sealing block 134 which is disposed between the upper flange assembly 112 and the lower flange assembly 116. The sealing block 134 generally comprises a ring or similar annular construction which has an upper groove and a lower groove such that the sealing block 134 is “H-shaped” in cross section. A first fluid seal 161 may be positioned in the upper groove, and a second fluid seal 162 may be positioned in the lower groove. An annular seat for receiving the sealing block 134 is formed in one of the upper flange assembly 112 or the lower flange assembly 116 adjacent the first and second fluid passageways 108A, 108B. In the embodiment shown in FIG. 4, the annular seat is formed in the upper flange assembly 112. In another embodiment (not shown), the annular seat may be formed in both the upper flange assembly 112 and the lower flange assembly 116 such that the sealing block is partially disposed in each of the upper flange assembly 112 and the lower flange assembly 116. The sealing block 134 may be constructed of Teflon or another suitable material. Each fluid seal 161, 162 may be constructed of rubber, nitrile, Teflon, or another suitable seating material. It is contemplated that other types and geometries of the sealing block may be used as well.

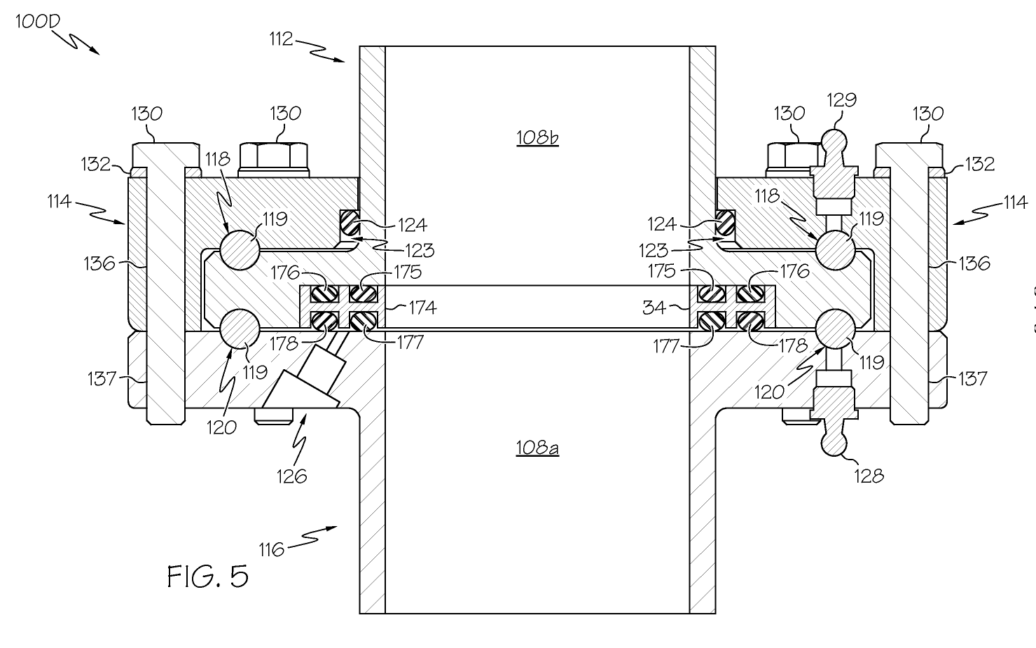

FIG. 5 depicts yet another embodiment of a swivel assembly 100D. This embodiment of the swivel assembly 100D also comprises a sealing block, like the embodiment of the swivel assembly 100C depicted in FIG. 4. However, the sealing block 174 depicted in FIG. 5 has four grooves (i.e., two upper grooves and two lower grooves) such that the sealing block 174 has a “double-H” shape in cross section. Four fluid seals 175, 176, 177, 178 are positioned in the grooves. The fluid seals 175, 176, 177, 178 keep the fluid flowing in the first and second fluid passageways 108A, 108B contained within the swivel assembly. Each fluid seal may be constructed of rubber, nitrile, Teflon, or another suitable sealing material. Like the embodiment in FIG. 4, the upper flange assembly 112 and/or lower flange assembly 116 may be formed with an annular seat in which the sealing block 174 may be positioned. Alternatively, the annular seat may be formed in both the upper flange assembly 112 and the lower flange assembly 116 such that at least a portion of the sealing block is positioned in each of the upper flange assembly 112 and the lower flange assembly 116. In this embodiment, the leak detection port 126 is positioned in the lower flange assembly 116 and located such that the leak detection port 126 is proximate to the centerline of the sealing block 174.

The embodiments of the swivel assembly shown in FIGS. 2-5 depict a cross section of the swivel assembly in which the upper flange assembly 112 is physically located on the top of the lower flange assembly 116. Consequently, the description herein refers to the “lower flange assembly,” “upper flange assembly,” and so forth. However, it is contemplated that the embodiments of the swivel assembly may be oriented in any direction. Thus, the labeling of the “upper flange assembly” and the “lower flange assembly,” etc., is for purposes of description only and is not intended to limit the orientation or location of the various component parts of the swivel assembly.

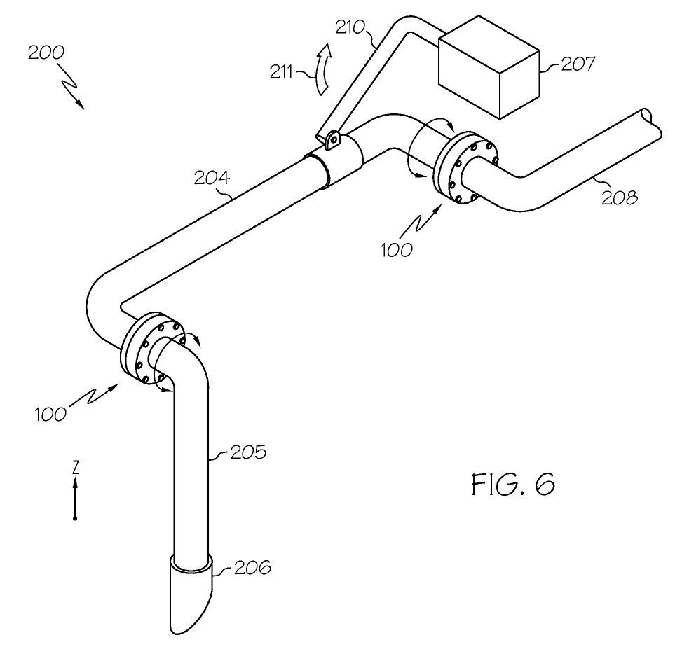

Referring now to FIG. 6, an exemplary loading arm 200 is schematically depicted. The loading arm 200 generally comprises a plurality of pipes 204, 205, 208 fluidly coupled with swivel assemblies 100. For example, in the embodiment illustrated in FIG. 6, the loading arm 200 comprises a supply pipe fluidly coupled to an intermediate pipe 204 with a swivel assembly 100. The intermediate pipe 204 is fluidly coupled to a coupling pipe 205 with a swivel assembly 100. The coupling pipe 205 is fluidly coupled to a coupling device 206 to facilitate connecting the loading arm to a bulk product transport. Each of the pipes 204, 205, 208 is connected to a respective swivel assembly 100 with an angled connection, such as the right angle connections in the embodiment shown, to facilitate articulating the loading arm 200 from a retracted position to an extended position and vice-versa.

The loading arm 200 further comprises a lifting mechanism 207, such as a motor, spring balance, pneumatic actuator or hydraulic actuator. The lifting mechanism 207 is mechanically coupled to the loading arm 200 with a lift arm 210. Actuation of the lifting mechanism 207 extends or retracts the loading arm 200. For example, actuation of the lifting mechanism 207 may retract the lift arm 210 in the direction shown by arrow 211 which, in turn, swivels the intermediate pipe 204 relative to the supply pipe 208 with swivel assembly 100 that couples the supply pipe 208 to the intermediate pipe 204. As the intermediate pipe 204 is raised, the coupling pipe 205 swivels relative to the intermediate pipe 204 with the swivel assembly 100 disposed between the intermediate pipe 204 and the coupling pipe 205 such that the coupling pipe remains substantially vertical (i.e., parallel to the z-direction depicted in FIG. 6) such that a transport vehicle may move to or from a loading position without interfering with the loading arm 200. When the transport vehicle is positioned in a loading position (i.e., in a position which facilitates product transfer through the loading arm 200), the lifting mechanism 207 may lower the loading arm 200 by moving the lift arm 210 in a direction opposite the direction indicated by arrow 211 such that the loading arm 200 is extended (as shown in FIG. 6) and the coupler 206 is positioned to be engaged with an adapter of the transport vehicle. Other types of loading arms having different mechanical arrangements are contemplated. For example, if the transport vehicle is a ship, the loading arm may have additional pipes and/or swivel assemblies to permit more degrees of freedom. This may allow the loading arm to move with the ship as it floats in the water.

The swivel assemblies described herein provide a robust mechanical design capable of withstanding high loads without binding or seizing. Moreover, the use of multiple seals prevents environmental contaminants from interfering with the operation of the swivel assembly while simultaneously preventing bulk product from leaking from the swivel assembly during transfer.

While particular embodiments and aspects of the present invention have been illustrated and described herein, various other changes and modifications may be made without departing from the spirit and scope of the invention. Moreover, although various inventive aspects have been described herein, such aspects need not be utilized in combination. It is therefore intended that the appended claims cover all such changes and modifications that are within the scope of this invention.

What is claimed is:

1. A swivel assembly for a loading arm, the swivel assembly comprising:
a lower flange assembly comprising a lower body portion and a first rim portion extending around the lower body portion, the lower body portion defining a first fluid passageway;
an upper flange assembly comprising an upper body portion and a second rim portion extending around the upper body portion, the upper body portion defining a second fluid passageway;
a mating collar positioned around the upper body portion of the upper flange assembly and secured to the first rim portion of the lower flange assembly such that the second rim portion of the upper flange assembly is rotatably positioned between the mating collar and the first rim portion of the lower flange assembly and the first fluid passageway is fluidly coupled to the second fluid passageway; and
a first plurality of bearing elements disposed between the first rim portion of the lower flange assembly and the second rim portion of the upper flange assembly and a second plurality of bearing elements disposed between the second rim portion and the mating collar such that the upper flange assembly and a combination of the lower flange assembly with the mating collar are rotatable with respect to each other.

2. The swivel assembly of claim 1 further comprising an environmental seal positioned between the mating collar and the upper flange assembly.

3. The swivel assembly of claim 1 further comprising at least one sealing element positioned between the first rim portion of the lower flange assembly and the second rim portion of the upper flange assembly.

4. The swivel assembly of claim 3, wherein the at least one sealing element comprises a first sealing element and a second sealing element, wherein the second sealing element is positioned radially outward from the first sealing element.

5. The swivel assembly of claim 3 further comprising a leak detection port formed in the first rim portion of the lower flange assembly, wherein the leak detection port is positioned radially outward of the at least one sealing element.

6. The swivel assembly of claim 1 wherein:
the first plurality of bearing elements are disposed in a lower bearing race formed between the first rim portion of the lower flange assembly and the second rim portion of the upper flange assembly; and
the second plurality of bearing elements are disposed in an upper bearing race formed between the second rim portion of the upper flange assembly and the mating collar.

7. A swivel assembly for a loading arm, the swivel assembly comprising:
a lower flange assembly comprising a lower body portion and a first rim portion extending around the lower body portion, the lower body portion defining a first fluid passageway and the first rim portion comprising a lower flange mating surface having a first half of a lower bearing race formed therein;
an upper flange assembly comprising an upper body portion and a second rim portion extending around the upper body portion, the upper body portion defining a second fluid passageway and the second rim portion comprising:
a first upper flange mating surface with a second half of the lower bearing race formed therein;
a second upper flange mating surface with a first half of an upper bearing race formed therein, wherein the lower flange mating surface of the lower flange assembly is positioned opposite the first upper flange mating surface such that the first half of the lower bearing race and the second half of the lower bearing race are aligned and the first fluid passageway is fluidly coupled to the second fluid passageway;
a mating collar positioned around the upper body portion of the upper flange assembly and secured to the first rim portion of the lower flange assembly such that the second rim portion of the upper flange assembly is rotatably positioned between the mating collar and the first rim portion of the lower flange assembly, the mating collar comprising a second half of the upper bearing race, wherein the second half of the upper bearing race and the first half of the upper bearing race are aligned; and
a first plurality of bearing elements disposed in the lower bearing race and a second plurality of bearing elements disposed in the upper bearing race such that the upper flange assembly and a combination of the lower flange assembly and the mating collar are rotatable with respect to each other.

8. The swivel assembly of claim 7 further comprising an environmental seal positioned between the mating collar and the upper flange assembly.

9. The swivel assembly of claim 7 further comprising a first fluid seal positioned between the upper flange assembly and the lower flange assembly.

10. The swivel assembly of claim 9 wherein the first rim portion of the lower flange assembly comprises a first annular channel formed in the lower flange mating surface and the first fluid seal is positioned in the first annular channel.

11. The swivel assembly of claim 9 wherein the first rim portion of the lower flange assembly comprises a leak detection port positioned radially outward from the first fluid seal.

12. The swivel assembly of claim 9 further comprising a second fluid seal positioned between the upper flange assembly and the lower flange assembly, wherein the second fluid seal is located radially outward from the first fluid seal.

13. The swivel assembly of claim 12, wherein the first rim portion of the lower flange assembly comprises a second annular channel formed in the lower flange mating surface and the second fluid seal is positioned in the second annular channel.

14. The swivel assembly of claim 7 wherein an outer surface of the first rim portion of the lower flange assembly is threaded and the mating collar comprises corresponding threads such that the mating collar and the lower flange assembly are threadably secured to one another.

15. The swivel assembly of claim 7 wherein:
the first rim portion of the lower flange assembly comprises a plurality of threaded holes;
the mating collar comprises a plurality of through-holes corresponding to the plurality of threaded holes; and
the mating collar is coupled to the lower flange assembly with bolts extending through the plurality of through-holes and threadably engaged with the plurality of threaded holes.

16. The swivel assembly of claim 7 further comprising an upper grease fitting fluidly coupled to the upper bearing race and a lower grease fitting fluidly coupled to the lower bearing race.

17. The swivel assembly of claim 7 further comprising:
an annular seat formed in at least one of the first rim portion of the lower flange assembly and the second rim portion of the upper flange assembly; and
a sealing block positioned in the annular seat, the sealing block comprising at least one upper groove in which one or more upper sealing members are positioned and at least one lower groove in which one or more lower sealing members are positioned, wherein the sealing block is oriented in the annular seat such that upper sealing members are sealed to the upper flange assembly and lower sealing members are sealed to the lower flange assembly.

18. The swivel assembly of claim 17 wherein the at least one lower groove is a single lower groove and the at least one upper groove is a single upper groove such that the sealing block has an H-shaped configuration.

19. The swivel assembly of claim 17 wherein the at least one lower groove is a pair of lower grooves and the at least one upper groove is a pair of upper grooves such that the sealing block has a double H-shaped configuration.

20. A loading arm comprising:
a first swivel assembly comprising:
a lower flange assembly comprising a lower body portion and a first rim portion extending around the lower body portion, the lower body portion defining a first fluid passageway;
an upper flange assembly comprising an upper body portion and a second rim portion extending around the upper body portion, the upper body portion defining a second fluid passageway;
a mating collar positioned around the upper body portion of the upper flange assembly and secured to the first rim portion of the lower flange assembly such that the second rim portion of the upper flange assembly is rotatably positioned between the mating collar and the first rim portion of the lower flange assembly and the first fluid passageway is fluidly coupled to the second fluid passageway;
a first plurality of bearing elements disposed between the first rim portion of the lower flange assembly and the second rim portion of the upper flange assembly and a second plurality of bearing elements disposed between the second rim portion and the mating collar such that the upper flange assembly and a combination of the lower flange assembly with the mating collar are rotatable with respect to each other;
a coupler pipe segment fluidly coupled to the first fluid passageway of the lower flange assembly of the first swivel assembly; and
an intermediate pipe segment fluidly coupled to the second fluid passageway of the upper flange assembly such that the coupler pipe segment and the intermediate pipe segment are rotatable with respect to one another, wherein the first swivel assembly fluidly couples the coupler pipe segment to the intermediate pipe segment.
